(19) United States
(12) Patent Application Publication
(10) Pub. No.: US 2012/0163367 A1
(43) Pub. Date: Jun. 28, 2012

(54) APPARATUS AND METHOD FOR ACQUIRING SYNCHRONIZATION IN WIRELESS COMMUNICATION SYSTEM

(75) Inventors: Eun Young CHOI, Daejeon-si (KR); Hun Sik KANG, Daejeon-si (KR); Sok Kyu LEE, Daejeon-si (KR)

(73) Assignee: Electronics and Telecommunications Research Institute, Daejeon-si (KR)

(21) Appl. No.: 13/333,735

(22) Filed: Dec. 21, 2011

(30) Foreign Application Priority Data
Dec. 23, 2010 (KR) 10-2010-0133437

(51) Int. Cl. H04J 3/06

(52) U.S. Cl. 370/350

(57) ABSTRACT

An apparatus for acquiring synchronization using a signal having repetition patterns is provided. The apparatus includes: a signal reception unit for receiving signal streams transmitted in the repetition patterns, a synchronization point tracking unit for calculating, during one period in which the signal streams are repeated in the repetition patterns, an add-sum of the signal streams, a sub-sum of the signal streams and an add-sub-sum which is a difference between the add-sum and the sub-sum, and for tracking an estimated synchronization point by comparing the sub-sum and the add-sub-sum, and a synchronization acquisition unit for acquiring, based on the estimated synchronization point, a synchronization point by searching for a point where the repetition of some of the signal streams is ended or a point where new signal streams having different characteristics from the signal streams are started.

Priority to Korean patent application number 10-2010-0133437 filed on Dec. 23, 2010, the entire disclosure of which is incorporated by reference herein, is claimed.

### BACKGROUND OF THE INVENTION

1. Field of the Invention

The present invention relates to wireless communication and, more particularly, to an apparatus and method for acquiring synchronization in a wireless communication system.

2. Discussion of the Related Art

In a wireless communication system (for example, a wireless LAN wireless system), synchronization for a receiver is provided by transmitting signal streams of repetition patterns known to both a transmission stage and a reception stage. The receiver can estimate the signal streams of the repetition patterns, calculates a maximum value from among values obtaining by correlating the current known current signal and a shifted signal, and acquire the synchronization of a frame when the maximum value is a certain value or higher. If a value in which the signal stream already known to the receiver is matched with an actually received signal stream is a predetermined level or higher, a synchronization time can be found. In other words, a pattern of the already known signal stream is matched with the signal stream received by the receiver, which is used for synchronization.

In a channel environment having a relatively low Signal to Noise Ratio (SNR), however, it may be difficult to accurately determine the synchronization time because a difference between a normal signal and a noise signal is not great. Furthermore, a great computational load is required when the signal streams are matched. Moreover, with an increase of a Root Mean Square (RMS) delay in the fading channel, the ability to detect synchronization is degraded, thereby significantly deteriorating system performance. A method of matching the pattern of a signal stream already known to a receiver with an actually received signal stream, as in the prior art under such circumstances, increases the probability of failed synchronization acquisition, thereby deteriorating system performance. Accordingly, not the method of acquiring synchronization by matching a predetermined signal stream with an actually received signal stream, but a new apparatus and method for acquiring synchronization is required.

### SUMMARY OF THE INVENTION

It is an object of the present invention to provide an apparatus and method for acquiring synchronization by using the periodicity of signal streams received by a receiver.

It is another object of the present invention to provide an apparatus and method for acquiring synchronization by finding the end of signal streams having the same periodicity.

It is yet another object of the present invention to provide an apparatus and method for acquiring synchronization by using a correlation between a signal received in a current period and a signal received in a next period when received signal streams have periodicity.

It is still yet another object of the present invention to provide an apparatus and method for acquiring synchronization by comparing the sum of a signal received in a current period and a signal received in a next period and the difference between them.

According to an aspect of the present invention, there is provided an apparatus for acquiring synchronization using a signal having repetition patterns which includes: a signal reception unit for receiving signal streams transmitted in the repetition patterns, a synchronization point tracking unit for calculating, during one period in which the signal streams are repeated in the repetition patterns, an add-sum of the signal streams, a sub-sum of the signal streams and an add-sub-sum which is a difference between the add-sum and the sub-sum, and for tracking an estimated synchronization point by comparing the sub-sum and the add-sub-sum, and a synchronization acquisition unit for acquiring, based on the estimated synchronization point, a synchronization point by searching for a point where the repetition of some of the signal streams is ended or a point where new signal streams having different characteristics from the signal streams are started.

The synchronization point tracking unit may determine a point of time where the sub-sum is identical to the add-sub-sum as the estimated synchronization point.

The signal streams may comprise Short Training Fields (STFs).

The new signal streams may comprise Long Training Fields (LTFs).

The add-sum may be an add-sum of power of the signal streams and the sub-sum is a sub-sum of power of the signal streams.

The estimated synchronization point tracking unit may determine a unique division value based on a relative magnitude difference between the add-sum and the sub-sum and calculates a compensated add-sub-sum by dividing the add-sub-sum by the unique division value.

The synchronization point tracking unit may acquire the estimated synchronization point based on the compensated add-sub-sum.

According to another aspect of the present invention, there is provided a method of acquiring synchronization using a signal having repetition patterns which includes receiving signal streams transmitted in the repetition patterns, calculating, during one period in which the signal streams are repeated in the repetition patterns, an add-sum of the signal streams, a sub-sum of the signal streams and an add-sub-sum which is a difference between the add-sum and the sub-sum, tracking an estimated synchronization point by comparing the sub-sum and the add-sub-sum, and acquiring, based on the estimated synchronization point, a synchronization point by searching for a point where the repetition of some of the signal streams is ended or a point where new signal streams having different characteristics from the signal streams are started.

The estimated synchronization point may be determined as a point of time where the sub-sum is identical to the add-sub-sum.

The method further comprises increasing a slope count by 1 if the sub-sum, calculated every time from the point of time where the new signal streams are inputted, has a positive slope.

The synchronization point may be acquired based on the estimated synchronization point and the slope count.

The add-sum may be an add-sum of power of the signal streams and the sub-sum is a sub-sum of power of the signal streams.

The add-sum or the sub-sum may be an add-sum or a sub-sum of an absolute value of a Signal to Noise Ratio (SNR) of the signal streams.

The method further comprises: determining a unique division value based on a relative magnitude difference between the add-sum and the sub-sum, and calculating a compensated add-sub-sum by dividing the add-sub-sum by the unique division value.

The estimated synchronization point may be acquired based on the compensated add-sub-sum.

The slope count may be fixed to a predetermined maximum value if the slope count is more than the predetermined maximum value.

The slope count may be fixed to a predetermined minimum value if the slope count is the predetermined minimum value or less.

According to another aspect of the present invention, there is provided a method of acquiring synchronization using a signal having repetition patterns which includes calculating, during one period, an add-sum of signal streams received in the repetition patterns, a sub-sum of the signal streams, and an add-sub-sum which is a difference between the add-sum and the sub-sum, calculating a compensated add-sub-sum by dividing the add-sub-sum by a specific value, and acquiring a point of time where new signal streams, having different characteristics from the signal streams, are started based on a estimated synchronization point where the compensated add-sub-sum is identical to the sub-sum.

A position of the estimated synchronization point may be changed by adjusting the compensated add-sub-sum.

The synchronization point tracking unit may increase a slope count by 1 if the sub-sum, calculated every time from the point of time where the new signal streams are inputted, has a positive slope, and the synchronization acquisition unit may acquire, based on the estimated synchronization point and the slope count, the synchronization point by searching for a point where the repetition of some of the signal streams is ended or a point where the new signal streams are started.

### BRIEF DESCRIPTION OF THE DRAWINGS

The above and other objects and features of the present invention will become apparent from the following description of preferred embodiments given in conjunction with the accompanying drawings, in which:

FIG. 1 is a flowchart illustrating a method of acquiring synchronization according to an embodiment of the present invention;

FIG. 2 is an explanatory diagram illustrating a process of tracking an estimated synchronization point according to an embodiment of the present invention;

FIG. 3 is an explanatory diagram illustrating a process of tracking an estimated synchronization point according to another embodiment of the present invention;

FIG. 4 is an explanatory diagram illustrating a process of tracking an estimated synchronization point according to yet another embodiment of the present invention;

FIG. 5 is a flowchart illustrating a method of adjusting the amount of an add-sub-sum according to an embodiment of the present invention;

FIG. 6 is a flowchart illustrating a method of determining the validity of a channel according to an embodiment of the present invention; and

FIG. 7 is a block diagram of a synchronization acquisition apparatus according to an embodiment of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. In order to clarify a description of the present invention, a description of parts not related to the description is omitted, and the same reference numbers are used throughout the drawings to refer to the same or like parts.

Furthermore, when it is said that a part “includes (or comprises)” any constituent element, it means the part may further include other constituent elements unless otherwise described without excluding other constituent elements. In addition, the term “ . . . unit” described in the specification means a unit for processing at least one function or operation, and it may be implemented by hardware or software or a combination of hardware and software.

The embodiments of the present invention will now be described with reference to the accompanying drawings.

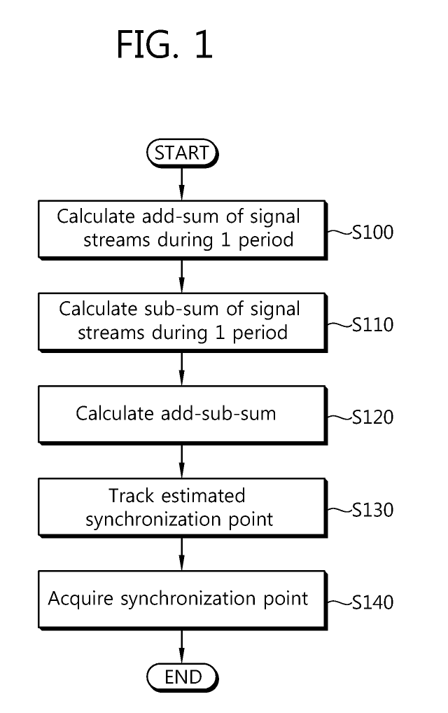

FIG. 1 is a flowchart illustrating a method of acquiring synchronization according to an embodiment of the present invention.

Referring to FIG. 1, a receiver calculates the add-sum A of signal streams during one period at step S100. The one period includes a plurality of repeated signal streams. For example, in the case where one period consists of 16 repeated signal streams, the add-sum of signal streams during one period means the add-sum of the 16 repeated signal streams. The signal stream is information known to both a transmitter and a receiver and is used for the detection of an initial signal, control of a signal gain, the estimation and compensation of a frequency offset, the detection of a system synchronization time. The signal streams are repeated with periodicity. For example, in systems, such as IEEE 802.11a/n, ten Short Training Fields (hereinafter referred to as STFs) and two Long Training Fields (hereinafter referred to as LTFs) are attached to the starting end of a signal stream.

For example, the add-sum of the signal streams during one period may be the add-sum of pieces of power of each signal stream. In this case, the add-sum may be calculated using the following equation.

add-sum=Σ(rₙ+rₙ₋ₚ)² [Equation 1]

In the add-sum, rₙ is an n^{th} signal stream, and p indicates the number of signal streams or the length of one period constituting the add-sum. rₙ and rₙ₋ₚ indicate reception data corresponding to the same position within one period at an interval of one period. All data having repetition patterns and data having previous patterns during one period are summed by adding a current reception signal rₙ to a reception signal rₙ₋ₚ before one period.

For another example, the add-sum of signal streams during one period may be an absolute value of the add-sum of intensities (for example, SNRs) of each signal stream. In this case, the add-sum may be calculated using the following equation.

add-sum=Σ|rₙ+rₙ₋ₚ| [Equation 2]

Meanwhile, a receiver cumulatively calculates the add-sum of signal streams during one period as the signal streams flow. Here, the signal stream means the add-sum of a currently received signal stream and a signal stream received before one period. That is, data at the same position is added at an interval of one period, and the add-sum is accumulated for one period. After one period elapses at the time of accumulation, a next signal is received, and the value of a new sum except the first cumulative value is used. For example, assuming that 16 identical signal streams are repeated during one period, after the sixteenth signal stream is received, a receiver cumulatively sums up the first signal stream of a second next period, but excludes the first signal stream of a first previous period from the add-sum. According to this method, whenever a signal stream is received, the add-sum will always become the add-sum of signal streams during one period.

The receiver calculates a sub-sum B of the signal streams during the one period at step S110. Like the method of calculating the add-sum, the sub-sum is calculated by using a cumulative difference between signal streams during one period. The sub-sum can be calculated using Equation 3 or Equation 4 below.

sub-sum=Σ(rₙ−ₙ₋ₚ)² [Equation 3]

sub-sum=Σ|rₙ−rₙ₋ₚ| [Equation 4]

When the add-sum and the sub-sum are accumulated during one period, the add-sum and the sub-sum maintain respective certain amount A and B according to a lapse of time (A>B).

Although the step S110 is illustrated to be later than the step S100, there is no limit to the sequence. That is, the steps S100 and S110 may be performed at different times. Furthermore, the step S110 may be first performed and the step S100 may be then performed, or the steps S100 and S110 may be performed at the same time.

The receiver calculates an add-sub-sum C which is a difference between the add-sum and the sub-sum of the signal streams during the same one period in each channel at step S120. The add-sub-sum may be calculated using Equation 5 below.

add-sub-sum=(add-sum)−(sub-sum) [Equation 5]

The receiver tracks a estimated synchronization point at step S130. The estimated synchronization point may be tracked using the following method. For example, the receiver may use a point of time at which the add-sum is identical to the sub-sum as the estimated synchronization point. If signal streams having a different characteristic from the same signal stream repeated are cumulatively added, the amounts of the add-sum and the sub-sum are changed. For example, the add-sum may be decreased from an amount A with a negative slope, and the sub-sum may be increased from an amount B with a positive slope. In this case, the receiver can estimate that signal streams of the same pattern are ended and signal streams of a new form are started, at a point of time at which a final value where the add-sum has been decreased is identical to a final value where the sub-sum has been increased.

For another example, the receiver may use a point of time at which the sub-sum and the add-sub-sum are identical to each other as the estimated synchronization point.

The receiver acquires an actual synchronization point on the basis of the estimated synchronization point at step S140. For example, synchronization may be acquired on the basis of the start or end point of another signal stream having a new characteristic. A system may become less sensitive to a fading channel by searching for the end point of signal streams having the same periodicity using signal streams received as described above. A method of acquiring an actual synchronization point on the basis of a estimated synchronization point is described below.

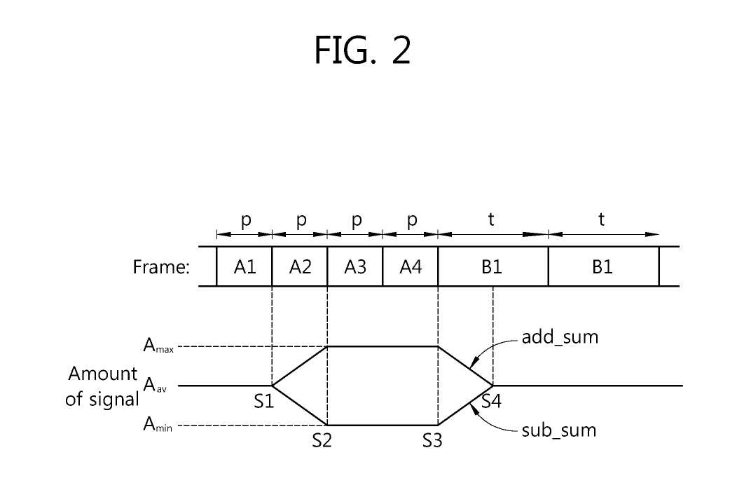

FIG. 2 is an explanatory diagram illustrating a process of tracking an estimated synchronization point according to an embodiment of the present invention. In FIG. 2, a frame structure in a wireless LAN system is illustrated. However, the frame structure is not limited to the wireless LAN system, but may be applied to systems having a frame structure with the same repeated signal streams.

Referring to FIG. 2, a transmitter transmits a frame consisting of LTF B1, B2, . . . , repeated in a period of t (or a t number of the same signal streams), after STFs A1, A2, A3, and A4 repeated in a period of p (or a p number of the same signal streams).

Meanwhile, a figure under the frame shows the amounts of an add-sum and a sub-sum of the signal streams calculated by a receiver.

It is assumed that the receiver has cumulatively calculated the add-sum and sub-sum of the signal streams from the STF A2 in order to acquire synchronization. A default value of each of the add-sum and the sub-sum is Aₐᵥ (that is, a mean value) because the add-sum or sub-sum of the signal streams is not cumulatively calculated before a point S1.

The add-sum and the sub-sum from the point S1 to a point S2 are calculated below. The add-sum is a cumulatively added value during one period and thus increased with positive slope. The sub-sum is decreased with a negative slope. Next, when the point S2 is reached, all the signal streams during one period are added, and the amount of the add-sum becomes Aₘₐₓ and the amount of the sub-sum becomes Aₘᵢₙ. Next, since only the signal streams during one period are cumulatively added or subtracted from the point S2 to a point S3, the amount of the add-sum is constantly Aₘₐₓ and the amount of the sub-sum is constantly Aₘᵢₙ. For example, when p=2, the add-sum of two signal streams added at an interval of one period is k times the amount of an original signal stream. In the sub-sum of two signal streams cumulatively subtracted at an interval of one period, actual data are excluded from the signal streams, and only noise remains.

Assuming that a received signal is r₁=a₁+n₁, r₂=a₂+n₂ when a frequency offset exists, the add-sum of two signals is r₁+r₂=a₁+a₂+n₁+n₂, and the sub-sum of the two signals is r₂−r₁=a₂−a₁+n₂−n₁. r₁ and r₂ are repeated data. Assuming that a₁ and a₂ are data having the same amount with a frequency offset e^{pθ} (that is, a frequency offset amount of one period p), the amounts of the add-sum and the sub-sum are different according to a ratio of (130 e^{pθ}) and (1−e^{pθ}) with noise being almost disregarded in a high SNR. In a low SNR, however, the ratio of (1+e^{pθ}) and (1−e^{pθ}) becomes small because the amount of nose is relatively great. Frequency compensation is performed according to the SNR.

Next, since the new LTF having a different periodicity t from the previous signal stream is started from the point S3, the cumulative value of the add-sum starts decreasing with a negative slope, and the cumulative value of the sub-sum starts increasing with a positive slope. If signal streams having a different periodicity are added or common data without periodicity are added or subtracted as described above, the cumulative value of the signal streams gradually becomes close to a mean value. That is, the amounts of the add-sum and the sub-sum are met at a point S4 where the periodicity p is ended.

According to a lapse of time from the point S3 to the point S4, the sub-sum is increased with a positive slope. When a estimated synchronization point (that is, the point S4) where the add-sum and the sub-sum are met is after the point S3 can be checked using the above characteristic.

The receiver uses the point S4 as a estimated synchronization point and tracks the point S3 (that is, an actual synchronization point) on the basis of the estimated synchronization point.

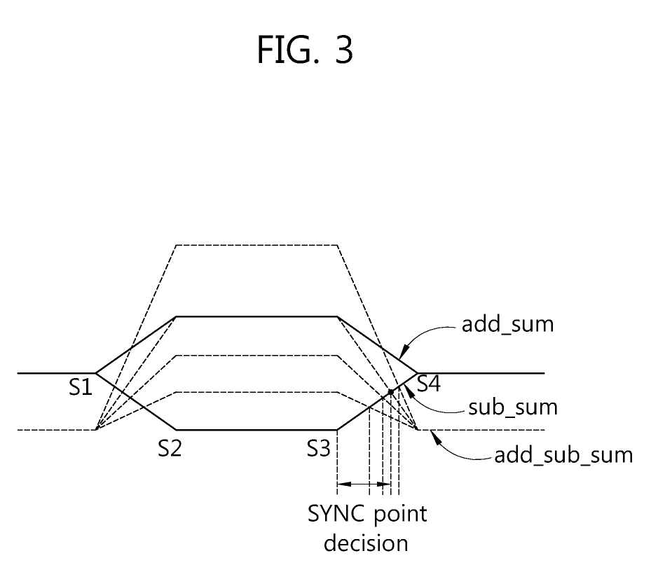

Here, the receiver may count the number of times that the cumulative sum of every signal stream is maintained at a positive slope from the point S3. This is because a point where each signal stream is ended or started can be known based on the count. Meanwhile, if a point where the add-sum and the sub-sum are met is found, the two values may exceed the point S4 according to environments. In this case, the add-sub-sum (that is, a difference between the add-sum and the sub-sum) is used in order to prevent the determination point from being pushed back. The add-sub-sum is described in more detail below with reference to FIG. 3.

FIG. 3 is an explanatory diagram illustrating a process of tracking an estimated synchronization point according to another embodiment of the present invention.

From FIG. 3, it can be seen that the amounts of an add-sum and a sub-sum of signal streams, calculated by a receiver, and the amount of an add-sub-sum between the add-sum and the sub-sum are changed. First, the amount of each of the add-sum and the sub-sum prior to a point Si is Aₐᵥ (that is, a mean value). However, the amount of the add-sub-sum is found as Aₘᵢₙ.

When the add-sum and the sub-sum of signal streams are cumulatively calculated at an interval of one period according to a lapse of time, the add-sum from the point S1 to a point S2 is increased with a positive slope, and the sub-sum from the point S1 to the point S2 is decreased with a negative slope. The amount of the add-sub-sum is variably found according to the amounts of the add-sum and the sub-sum. Here, the amounts of the add-sum and the sub-sum can be controlled so that they have a specific value between a transmitter and a receiver. Accordingly, the transmitter and the receiver can estimate an amount of the add-sub-sum.

In any case, the add-sub-sum and the add-sum should be met between a point S3 and a point S4 in theory. Likewise, the add-sub-sum and the sub-sum must be met between the point S3 and the point S4. It would be very efficient to use the add-sub-sum in determining a synchronization point because information about the slope of the sub-sum to determine synchronization can be used less sensitively in the case where the estimated synchronization point becomes earlier.

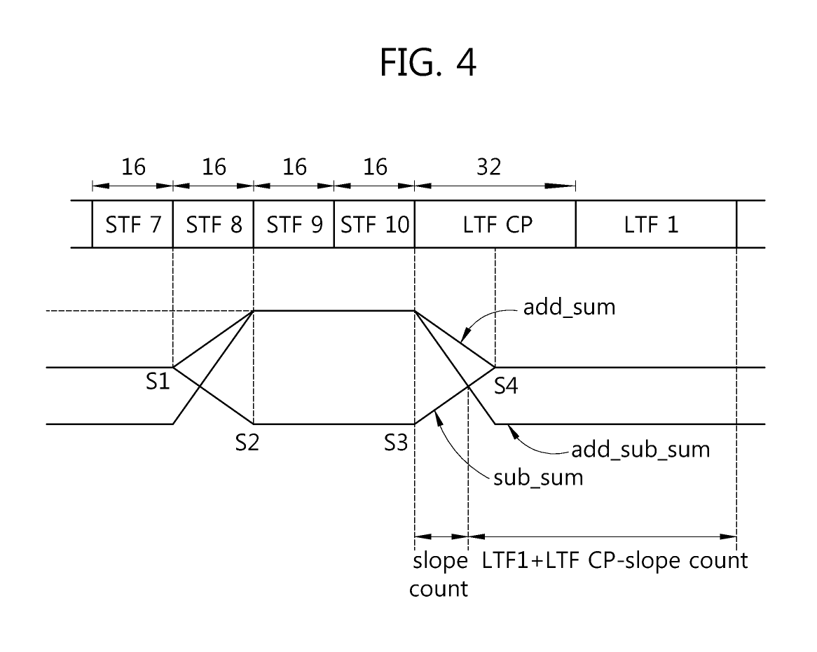

FIG. 4 is an explanatory diagram illustrating a process of tracking an estimated synchronization point according to yet another embodiment of the present invention. FIG. 4 shows an example in which the process is used in an IEEE 802.11a/n system.

Referring to FIG. 4, a frame of the IEEE 802.11a/n system consists of 10 STFs and 2 LTFs. Each of the STFs includes 16 identical signal streams. Each of the LTFs includes 64 identical signal streams, and LT CPF(Long Training Cyclic Prefix Field) uses 32 signal streams that are the rear portion of LTF. A receiver can determine a synchronization point using the signal streams of STFs repeated at an early stage. Assuming that about the last 3 of the initially repeated STFs is used for synchronization, the following timing is obtained.

An intersecting point of the add-sub-sum and the sub-sum found in the STF 8 to the STF 10 becomes an estimated synchronization point. The receiver can search a synchronization point on the basis of the estimated synchronization point and a slope count. For example, the receiver may find the slope count (that is, the number of times that the sub-sum has a positive slope from a point S3 to the estimated synchronization point) and use the slope count to calculate the end point of an LTF1. More particularly, the receiver can check the end of the LTF1 by adding the length of an LTF CP and the length of the LTF1 after the STF 10 and then subtracting the slope count up to an estimated synchronization point from the addition, as in Equation 6.

end of LTF1=LTF1+LTF CP-slope count [Equation 6]

Furthermore, in the case where the process is implemented in a system, the start point of the LTF1 may be used as a synchronization point if an estimated synchronization point is determined within the time of the LTF CP by taking a calculation time delay into consideration.

Here, with an increase of the amount of the add-sub-sum, the estimated synchronization point gradually becomes a point S4. If the slope count is started in advance or a problem, such as poor channel conditions, is generated up to the point S4, the accuracy of synchronization estimation may be reduced. Accordingly, it is preferred that the estimated synchronization point be close to the point S3 to the highest degree. The estimated synchronization point may be adjusted by controlling the amount of the add-sub-sum. Hereinafter, a method of adjusting the amount of the add-sub-sum so that the estimated synchronization point becomes close to the point S3 is described below.

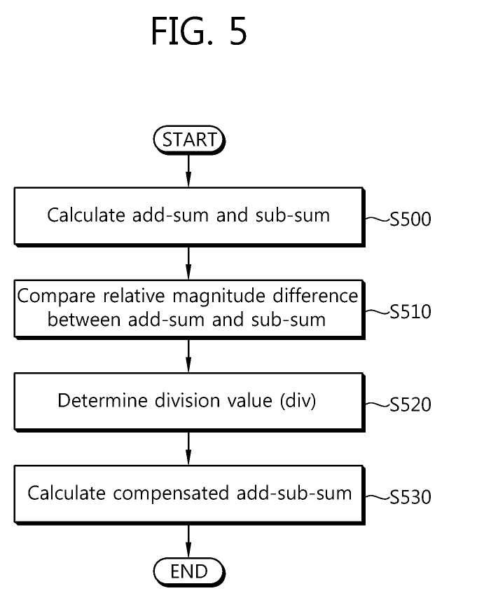

FIG. 5 is a flowchart illustrating the method of adjusting the amount of the add-sub-sum according to an embodiment of the present invention. For the method, reference can be made to FIG. 3, showing the example in which the amount of the add-sub-sum is varied.

Referring to FIG. 5, the receiver calculates the add-sum and the sub-sum at the point S2 at step S500. Since the add-sum and the sub-sum are stabilized from the point S2, the amount of the add-sub-sum can be adjusted on the basis of the point S2.

The receiver compares the amount of the add-sum and the amount of the sub-sum at step S510 and determines a division value div at step S520. For example, if the add-sum is n times greater than the sub-sum, the receiver may determine an appropriate division value div obtained by dividing the amount of the add-sub-sum by taking an n value into consideration. For example, the division value div may be determined using the following equation.

$$div = \frac{1}{2} {log}_{2} n \qquad [ Equation 7 ]$$

As the n value is varied, the division value div can be determined as in the following table.

TABLE 1

| n | div |
|---|---|
| 1024 | 5 |
| 256 | 4 |
| 64 | 3 |
| 16 | 2 |
| 4 | 1 |
| 2 | 0 |

If the add-sum is not n times greater than the sub-sum, the receiver determines the division value div as −1.

In some embodiments, the division value div may be determined on the basis of an n value which is satisfied for the first time by sequentially substituting 1024, 236, . . . , 2 into all the n values listed in Table 1.

After the division value div is determined, the receiver calculates a compensated add-sub-sum by dividing the amount of the add-sub-sum by the division value div at step S530. Furthermore, an estimated synchronization point is determined by comparing and analyzing the compensated add-sub-sum and the sub-sum. In this case, the estimated synchronization point is close to the point S3, as compared with the case where the existing add-sub-sum not compensated is substituted.

Meanwhile, the range of a slope count can be determined along with each division value div. The range of the slope count may be set to be automatically determined when the division value div is determined. For example, the division value div and the range of the slope count may be determined as in Table 2 below.

TABLE 2

| div | RANGE OF SLOPE COUNT |
|---|---|
| 5 | SCmax = 0, SCmin = 0 |
| 4 | SCmax = 1, SCmin = 0 |
| 3 | SCmax = 4, SCmin = 0 |
| 2 | SCmax = 8, SCmin = 0 |
| 1 | SCmax = 10, SCmin = 4 |
| 0 | SCmax = 12, SCmin = 8 |

Referring to Table 2, SCmax indicates a maximum value of the slope count SC, and SCmin is a minimum value of the slope count SC. Here, if the division value div is −1, the maximum value SCmax is 15, and the minimum value SCmin is 15. The maximum value SCmax and the minimum value SCmin are parameters which are used to compensate for a problem that the slope count is started in advance owing to a deteriorated channel. For example, there may be a case where the slope count theoretically expected from the point S3 to an estimated synchronization point is 7, but the slope count is started in advance, thus excessively becoming 12. In this case, if the maximum value of the slope count is [symbol] 10, a receiver disregards the actual slope count 12 and fixes the slope count at the estimated synchronization point to 10 in order to prevent error in synchronization estimation. In other words, the slope count is fixed to a predetermined maximum value SCmax if it exceeds the predetermined maximum value SCmax and is fixed to a predetermined minimum value SCmin if it becomes less than the predetermined minimum value SCmin.

The slope count of a positive slope of the sub-sum can be adjusted by controlling the amount of the add-sub-sum as described above. Accordingly, a synchronization point can be determined more accurately.

An IEEE 802.11 n system uses a 40 MHz bandwidth twice the bandwidth of an IEEE 802.11a system. In this case, only actually valid information may be used by determining whether pieces of information received from two channels (each having 20 MHz) are valid. There is a need for a method of determining the validity of a channel in a multi-channel system as described above.

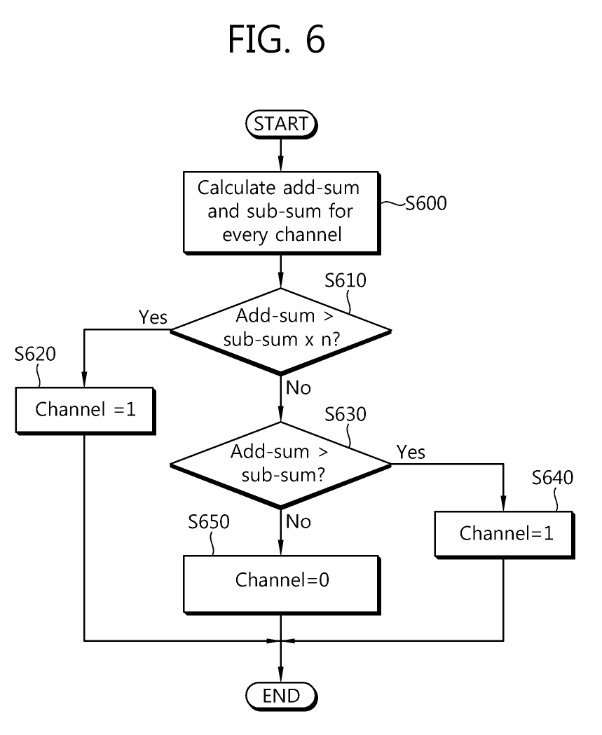

FIG. 6 is a flowchart illustrating the method of determining the validity of a channel according to an embodiment of the present invention.

Referring to FIG. 6, a receiver calculates a cumulative add-sum and sub-sum of signal streams transmitted during one period for every channel at step S600.l For example, assuming that the multiple channels includes a first channel and a second channel, the receiver may calculate a first add-sum1 and a first sub-sum1 of the first channel and a second add-sum2 and a second sub-sum2 of the second channel. Here, the multiple channels are not necessarily transmitted from different transmitters, but one transmitter may transmit a plurality of channels.

The receiver may determine whether a relative magnitude difference between the add-sum and the sub-sum for every channel is more than a certain critical value at step S610. For example, the receiver may determine whether the add-sum is n times the sub-sum.

If, as a result of the determination, the relative magnitude difference is determined to be more than the certain critical value, the receiver determines that a corresponding channel is valid (that is, the first channel=1) at step S620. If, as a result of the determination, the relative magnitude difference is determined to be the certain critical value or less, the receiver compares the amounts of the add-sum and the sub-sum for every channel again at step S630. Here, if, as a result of the determination, the add-sum is greater than the sub-sum, the receiver determines that a corresponding channel is valid at step S640.

If, as a result of the determination, the add-sum is not greater than the sub-sum, the receiver determines that a corresponding channel is invalid at step S650. The receiver may perform the steps S600 to S650 for every channel individually or simultaneously.

A multi-channel system using several channels may determine whether the channels are actually used by determining whether the channels are valid channels for every channel or by exchanging pieces of information between the systems. Information about the determined channel may be used in a synchronization process. In other words, only information about actually used channels is used in the synchronization process. If a channel not used has heavy noise, it may have an effect on the synchronization performance. Accordingly, the deterioration of performance can be reduced by using information about actually used channels. Furthermore, in the case where a number of channels exist and each of the channels is for several users not for one user, each of the channels has an independent synchronization time if a channel is independently allocated.

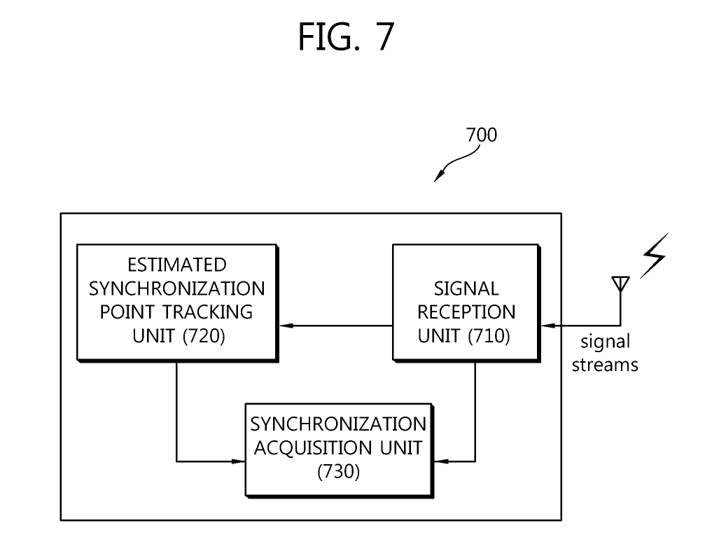

FIG. 7 is a block diagram of a synchronization acquisition apparatus according to an embodiment of the present invention.

Referring to FIG. 7, the synchronization acquisition apparatus 700 includes a signal reception unit 710, a synchronization point tracking unit 720, and a synchronization acquisition unit 730.

The signal reception unit 710 receives signal streams and data, transmitted in repetition patterns, from a transmitter.

The synchronization point tracking unit 720 cumulatively calculates an add-sum, a sub-sum, and an add-sub-sum of the signal streams according to a lapse of time during one period on the basis of the repetition patterns of the signal streams and tracks an estimated synchronization point by comparing and analyzing the add-sum, sub-sum, and add-sub-sum. A method of the synchronization point tracking unit 720 calculating the add-sum, the sub-sum, and the add-sub-sum of the signal streams may be performed using, for example, Equations 1 to 5. The synchronization point tracking unit 720 determines a point of time at which the sub-sum is identical to the add-sub-sum as the estimated synchronization point.

Meanwhile, the synchronization point tracking unit 720 may calculate a compensated add-sub-sum by compensating for the add-sub-sum as occasion demands. In this case, error generated in tracking the estimated synchronization point can be reduced. A process of the synchronization point tracking unit 720 calculating the compensated add-sub-sum may be performed using a method, such as that described with reference to FIG. 5.

Furthermore, the synchronization point tracking unit 720 determines whether the sub-sum has a positive slope according to a lapse of time. If, as a result of the determination, the sub-sum is determined to be a positive slope, the synchronization point tracking unit 720 increases a slope count by 1. After the estimated synchronization point or the compensated estimated synchronization point is determined, the synchronization point tracking unit 720 determines a first point where the repeated signal streams are ended or a second point where new signal streams are started on the basis of the estimated synchronization point or the compensated estimated synchronization point and the slope count.

Assuming that the new signal streams are an LTF CP and an LTF1 when the slope count at the estimated synchronization point is S_{A}, the end of the new signal stream LTF1 may be calculated using Equation 8 below.

end of LTF1=LTF1+LTF CP−S_{A} [Equation 8]

In order to compensate for the slope count in the case where the slope count is started faster than the point S3 or started after the point S3 owing to a degraded channel, the synchronization point tracking unit 720 may set the range of the slope count and compensate for the slope count. A transmitter and a receiver may previously set division values div and maximum and minimum values of the slope count, such as Table 1 and Table 2, in order to compensate for the slope count.

The synchronization acquisition unit 730 acquires a synchronization point regarding each of the channels on the basis of the first or second point determined by the synchronization point tracking unit 720. For example, the synchronization acquisition unit 730 may acquire the synchronization point according to Equation 6. The synchronization acquisition unit 730 may further include a buffer (not shown) for storing data for each of the channels until the synchronization point is acquired.

As described above, according to the present invention, there can be expected an improved performance effect in a low SNR or in a fading channel environment. Although the value of data of repeated signal streams is not known, synchronization can be acquired by using only the length of one period, thereby being capable of simplifying a synchronization acquisition procedure. Furthermore, the configuration of hardware can be simplified by using only the addition and subtraction of signals in a system configuration.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed to limit the technical spirit of the present invention, but should be construed to illustrate the technical spirit of the present invention. The scope of the technical spirit of the present invention is not limited by the embodiments, and the scope of the present invention should be interpreted based on the following appended claims. Accordingly, the present invention should be construed to cover all modifications or variations induced from the meaning and scope of the appended claims and their equivalents.

What is claimed is:

1. An apparatus for acquiring synchronization using a signal having repetition patterns, the apparatus comprising:
a signal reception unit for receiving signal streams transmitted in the repetition patterns;
a synchronization point tracking unit for calculating, during one period in which the signal streams are repeated in the repetition patterns, an add-sum of the signal streams, a sub-sum of the signal streams and an add-sub-sum which is a difference between the add-sum and the sub-sum, and for tracking an estimated synchronization point by comparing the sub-sum and the add-sub-sum; and
a synchronization acquisition unit for acquiring, based on the estimated synchronization point, a synchronization point by searching for a point where the repetition of some of the signal streams is ended or a point where new signal streams having different characteristics from the signal streams are started.

2. The apparatus of claim 1, wherein the synchronization point tracking unit determines a point of time where the sub-sum is identical to the add-sub-sum as the estimated synchronization point.

3. The apparatus of claim 1, wherein the signal streams comprise Short Training Fields (STFs).

4. The apparatus of claim 1, wherein the new signal streams comprise Long Training Fields (LTFs).

5. The apparatus of claim 1, wherein the add-sum is an add-sum of power of the signal streams and the sub-sum is a sub-sum of power of the signal streams.

6. The apparatus of claim 1, wherein the estimated synchronization point tracking unit determines a unique division value based on a relative magnitude difference between the add-sum and the sub-sum and calculates a compensated add-sub-sum by dividing the add-sub-sum by the unique division value.

7. The apparatus of claim 6, wherein the synchronization point tracking unit acquires the estimated synchronization point based on the compensated add-sub-sum.

8. A method of acquiring synchronization using a signal having repetition patterns, the method comprising:
receiving signal streams transmitted in the repetition patterns;
calculating, during one period in which the signal streams are repeated in the repetition patterns, an add-sum of the signal streams, a sub-sum of the signal streams and an add-sub-sum which is a difference between the add-sum and the sub-sum;
tracking an estimated synchronization point by comparing the sub-sum and the add-sub-sum; and
acquiring, based on the estimated synchronization point, a synchronization point by searching for a point where the repetition of some of the signal streams is ended or a point where new signal streams having different characteristics from the signal streams are started.

9. The method of claim 8, wherein the estimated synchronization point is determined as a point of time where the sub-sum is identical to the add-sub-sum.

10. The method of claim 8, further comprising:
increasing a slope count by 1 if the sub-sum, calculated every time from the point of time where the new signal streams are inputted, has a positive slope.

11. The method of claim 10, wherein the synchronization point is acquired based on the estimated synchronization point and the slope count.

12. The method of claim 8, wherein the add-sum is an add-sum of power of the signal streams and the sub-sum is a sub-sum of power of the signal streams.

13. The method of claim 8, wherein the add-sum or the sub-sum is an add-sum or a sub-sum of an absolute value of a Signal to Noise Ratio (SNR) of the signal streams.

14. The method of claim 8, further comprising:
determining a unique division value based on a relative magnitude difference between the add-sum and the sub-sum; and
calculating a compensated add-sub-sum by dividing the add-sub-sum by the unique division value.

15. The method of claim 14, wherein the estimated synchronization point is acquired based on the compensated add-sub-sum.

16. The method of claim 10, wherein the slope count is fixed to a predetermined maximum value if the slope count is more than the predetermined maximum value.

17. The method of claim 10, wherein the slope count is fixed to a predetermined minimum value if the slope count is the predetermined minimum value or less.

18. A method of acquiring synchronization using a signal having repetition patterns, the method comprising:
calculating, during one period, an add-sum of signal streams received in the repetition patterns, a sub-sum of the signal streams, and an add-sub-sum which is a difference between the add-sum and the sub-sum;
calculating a compensated add-sub-sum by dividing the add-sub-sum by a specific value; and
acquiring a point of time where new signal streams, having different characteristics from the signal streams, are started based on a estimated synchronization point where the compensated add-sub-sum is identical to the sub-sum,
wherein a position of the estimated synchronization point is changed by adjusting the compensated add-sub-sum.

19. The method of claim 1, wherein:
the synchronization point tracking unit increases a slope count by 1 if the sub-sum, calculated every time from the point of time where the new signal streams are inputted, has a positive slope, and
the synchronization acquisition unit acquires, based on the estimated synchronization point and the slope count, the synchronization point by searching for a point where the repetition of some of the signal streams is ended or a point where the new signal streams are started.
